(19) United States
(12) Patent Application Publication
(10) Pub. No.: US 2016/0246989 A1
(43) Pub. Date: Aug. 25, 2016

(54) COMPUTERIZED SYSTEM AND METHOD FOR SELECTIVELY RESTRICTING ACCESS TO HEALTH INFORMATION

(71) Applicant: APPLIED RESEARCH WORKS Inc., PALO ALTO, CA (US)

(72) Inventors: SHAIBAL ROY, PALO ALTO, CA (US); Yin Ling Leung, Palo Alto, CA (US); Anandini Wadera, San Mateo, CA (US)

(73) Assignee: APPLIED RESEARCH WORKS INC., Palo Alto, CA (US)

(21) Appl. No.: 14/628,193

(22) Filed: Feb. 20, 2015

(51) Int. Cl. G06F 21/62; H04L 29/06

(52) U.S. Cl. CPC G06F 21/6245; H04L 63/08; H04L 63/102

(57) ABSTRACT

Disclosed is a system and method restricting access to health information over a computer network comprising the steps of receiving settings for restricting access to health information from a first user, storing the settings for restricting access to health information on a central repository, authenticating a user, determining the authorization level of the user, redacting health information based on the user's authorization level, and displaying redacted health information to the user on a user interface. Also disclosed is a system and method for transmitting messages over a computer network with redacted health information.

### BACKGROUND

In healthcare settings, it is often necessary to restrict access to health information. Legal and regulatory requirements impose obligations on healthcare providers, and service providers having access to health information, to ensure health information is protected. In addition to restricting access to protected health information, certain health information requires additional protection. Medical information pertaining to HIV and pregnancy tests, and psychotherapy notes often require additional protections from disclosure. Consequently, it is often desirable to restrict access to certain users of an electronic health record (EHR).

The disclosed system and method address these concerns by providing a method for restricting access to certain health information based on system settings.

### SUMMARY OF THE INVENTION

Disclosed is a computerized system and method for selectively restricting access to health information. The disclosed system includes security features including encryption. System settings control what information is disclosed to various users of the system. Based on system settings, health information is redacted. In other embodiments, messages are transmitted through the system, with messages redacted based on the receiving user and in accordance with the system settings.

### BRIEF DESCRIPTION OF THE DRAWINGS

FIG. 1 illustrates an embodiment of a computer system, through which access to health information may be restricted in an electronic health record.

FIG. 2 illustrates an embodiment of a method for restricting access to health information over an

Electronic Health Network.

FIG. 3 illustrates an embodiment of a method for transmitting a secure message after screening the message for restricted health information.

### DETAILED DESCRIPTION

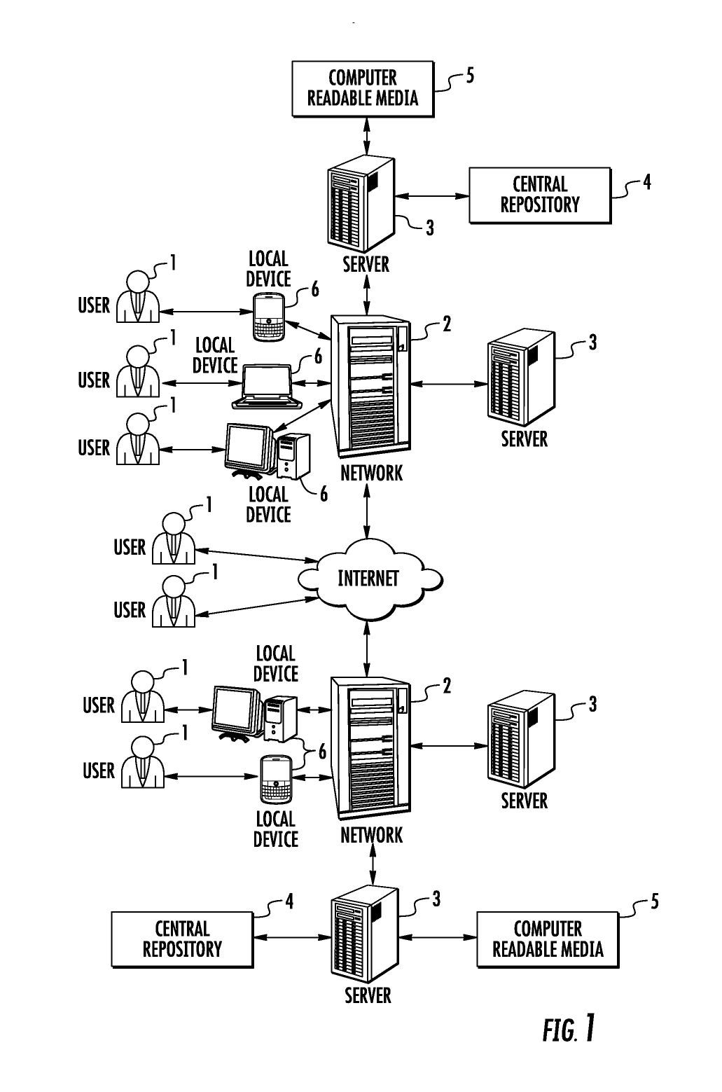

Disclosed is a system and method for sharing brief patient notes among users of an Electronic Medical Record (EHR), wherein the EHR is used for the storage, retrieval, and transmission of information in a healthcare setting. FIG. 1 illustrates a representative embodiment of the disclosed system. In certain embodiments, users 1 who share information over one or more internet based applications. Each user 1 is supplied with an account to access the EHR and the system. To access the system, each user must authenticate his or her identity. In certain embodiments, this authentication is performed by providing an assigned user name and password. In alternative embodiments, different or additional credentials may be required. Alternative embodiments comprise one or networks 2, which may be optionally coupled to the Internet. In certain embodiments, each of the networks 2 will utilize various security features to ensure the security and integrity of the system and data transmitted over the system. In certain embodiments, each network 2 will utilize secure connections (for example, Secure Sockets Layer, Transport Layer Security, or Secure/Multipurpose Internet Mail Extensions). The system comprises one or more servers 3, each server 3 coupled to one or more networks 2. In certain embodiments, one or more servers 3 are coupled to the Internet. In certain embodiments, each server 3 will be protected by one or more firewalls. Further, data on each server may be encrypted. In certain embodiments, non-transitory computer readable media 5 encoding instructions for carrying out various methods is coupled to one or more servers 3. Users connect to the system servers through various devices 6 having connections to one or more networks 2, or the Internet. In alternative embodiments, users may access the system through local area networks, telephonic devices, radio frequencies, computers, or other electronic devices. In certain embodiments, data obtained through, and transmitted over the system resides on one or more central repositories 4. The one or more central repositories 4 may be associated with thin or thick clients where data transmitted through the system will be synchronized. In certain embodiments, all data transmitted and displayed to users resides on the central repository 4.

The system may restrict access or transmission of certain information. System settings may be established to prevent transmission or disclosure to comply with legal or regulatory requirements, to comply with policies set forth by the system administrator, or to provide additional security within the system. Certain information may be restricted from disclosure or transmission to certain providers based on the role of the provider or the nature of information disclosed. For example, notes pertaining to psychotherapy are subject legal limitations on disclosure and information pertaining to tests for pregnancy and HIV are also subject to legal restrictions in many jurisdictions. The system settings could be set to restrict access to, and transmission of, psychotherapy notes to only mental health providers and restrict access to this information to all other users of the EHR who are not involved in the patient's mental health care.

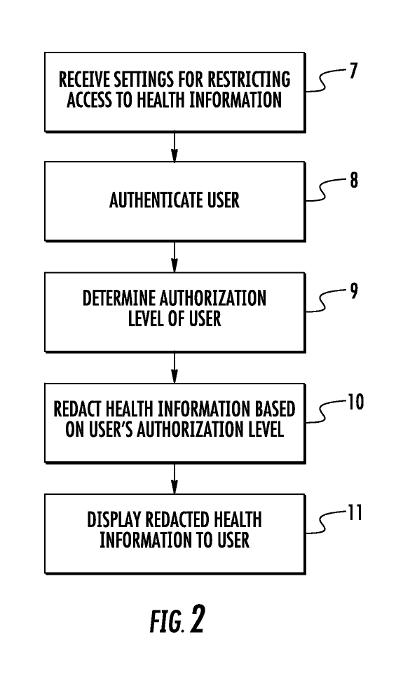

FIG. 2 illustrates an embodiment of a method to restrict access to, or transmission of, certain information. System settings are received 7 from a system administrator, or in certain embodiments, from individual users. The settings are stored on the central repository. The settings set forth the information a user may access. The user may be limited to accessing certain information based on the user's role (for example, a physician caring for a patient may have access to more information than a radiologic technician who will only perform a single imaging study). The settings will also set forth what information in the EHR specific users will have access to. The settings will be stored in the central repository. When a user logs onto the EHR through a user interface, the user will be authenticated 8. In certain embodiments, authentication is performed by receiving a correct username and password from the user. Alternatively, two factor authentication may be used in certain embodiments. When a user attempts to access a patient's health information, the system will determine the authorization level of the user 9 based on the system settings. The authorization levels of users are determined by the system settings. Higher authorization levels will allow access to more information than lower authorization levels. In a typical embodiment, treating physicals would have the highest authorization level (access to all health information regarding a given patient), and non-clinical personnel would have the lowest authorization level and would be able to access only the minimum information necessary. For example, a medical biller may have access to only patient financial information. The system will then redact the health information displayed to the user, based on the user's authorization level 10. Once redacted, the information will be displayed to a user 11.

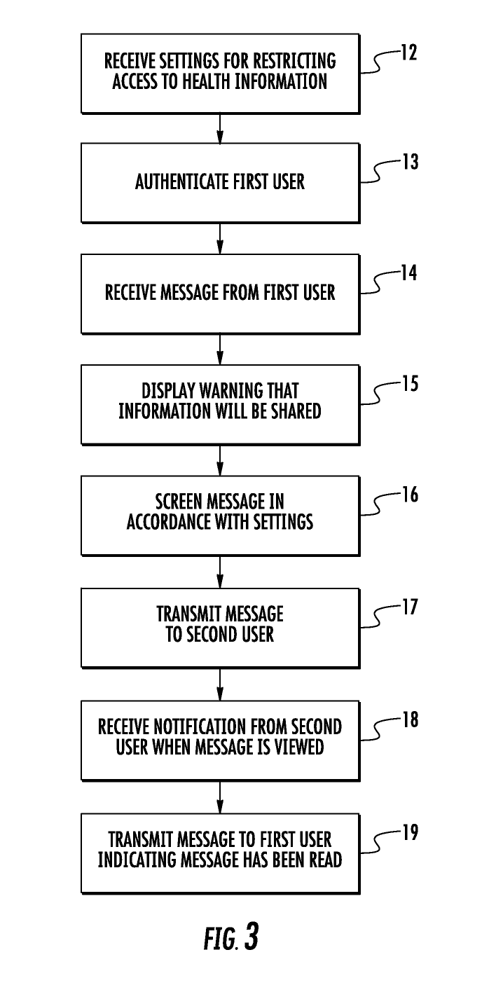

The system also has functions secure messaging. Messages may be obtained from users. FIG. 3 illustrates an embodiment of a method wherein secure messaging can be performed with restrictions in the information that will be shared. In such embodiments, settings for restricting access to health information are received 12 from users, typically users with administrative access, but any user may establish settings to redact information. In certain embodiments, such instructions are set as default settings for the entire system. In other embodiments, individual users may establish settings that will restrict access to certain health information. Once the first user is authenticated 13, the system will receive a message from the first user 14. The message may be generated through a user interface in an EHR. In certain embodiments, the user interface will provide a dialogue box in which a user can enter text or select attachments to the message. Before storing and transmitting the message, the system will display a warning to the user that information will be shared 15. The system then screens the message in accordance with the settings 16 for health information that should not be disclosed. The screening may be based on settings restricting access to health information based on a second user's role (for example, users who are not clinical providers may be restricted from seeing health information and may only be able to access financial information. The message will then be sent to a second user 17, with restricted information redacted. In certain embodiments, the message is transmitted through the system and displayed to the second user through a user interface. In other embodiments, the message is transmitted by email, SMS message, facsimile, or other electronic means. The message is also stored on the central repository. In certain embodiments, the system will receive a notification that the second user has viewed the message 18, and may transmit a message to the first user indicating the message has been read 19.

While the invention has been described and illustrated with reference to certain particular embodiments thereof, those skilled in the art will appreciate that the various adaptations, changes, modifications, substitutions, deletions, or additions or procedures and protocols may be made without departing from the spirit and scope of the invention. It is intended, therefore, that the invention be defined by the scope of the claims that follow and that such claims be interpreted as broadly as reasonable.

What is claimed is:

1. A method for selectively restricting access to health information over a computer network comprising the steps of:
receiving settings for restricting access to health information;
storing the settings for restricting access to health information on a central repository;
authenticating a user;
determining the authorization level of the user;
redacting health information based on the user's authorization level; and
displaying redacted health information to the user on a user interface.

2. The method for selectively restricting access to health information over a computer network of claim 1 comprising the step of utilizing two factor authentication to authenticate the user.

3. The method for selectively restricting access to health information over a computer network of claim 1 wherein data residing on servers coupled to the network are encrypted.

4. A method for transmitting messages over a computer network wherein access to health information is restricted comprising the steps of:
receiving settings for restricting access to health information;
authenticating a first user;
receiving a message from a first user through a user interface;
displaying a warning to the first user that information transmitted in the message will be shared;
redacting information contained in the message in accordance with the settings; and
transmitting a redacted message to a second user.

5. The method for transmitting messages over a computer network wherein access to health information is restricted of claim 4 further comprising the steps of:
storing the message on a central repository;
receiving a notification from the second user that the message has been read; and
transmitting a notification to the first use that the second user has read the message.

6. The method for transmitting messages over a computer network wherein access to health information is restricted of claim 4 wherein the redacted message is transmitted to the second user via email.

7. A computerized system for selectively restricting access to health information comprising:
one or more servers coupled to one or more computer networks;
a central repository coupled to the one or more servers; and
a computer readable media coupled to the one or more servers wherein the computer readable media comprises computer readable instructions for carrying out a method comprising the steps of:
receiving settings for restricting access to health information;
storing the settings for restricting access to health information on a central repository;
authenticating a user;
determining the authorization level of the user;
redacting health information based on the user's authorization level; and
displaying redacted health information to the user on a user interface.

8. The computerized system for selectively restricting access to health information of claim 7 wherein the computer readable media coupled to the one or more servers wherein the computer readable media comprises computer readable instructions for carrying out a method further comprises the step of utilizing two factor authentication to authenticate the user.

9. The computerized system for selectively restricting access to health information of claim 7 wherein data residing on servers coupled to the network are encrypted.

10. A computerized system for transmitting messages over a network wherein access to health information is restricted comprising:
one or more servers coupled to one or more computer networks;
a central repository coupled to the one or more servers; and
a computer readable media coupled to the one or more servers wherein the computer readable media comprises computer readable instructions for carrying out a method comprising the steps of:
receiving settings for restricting access to health information;
authenticating a first user;
receiving a message from a first user through a user interface;
displaying a warning to the first user that information transmitted in the message will be shared;
redacting information contained in the message in accordance with the settings; and
transmitting a redacted message to a second user.

11. The computerized system for transmitting messages over a network wherein access to health information is restricted of claim 10 wherein the computer readable media coupled to the one or more servers wherein the computer readable media further comprises computer readable instructions for carrying out a method comprising the steps of:
storing the message on a central repository;
receiving a notification from the second user that the message has been read; and
transmitting a notification to the first use that the second user has read the message.

12. The computerized system for transmitting messages over a network wherein access to health information is restricted of claim 10 wherein the computer readable media coupled to the one or more servers wherein the computer readable media further comprises computer readable instructions for carrying out a method wherein the redacted message is transmitted to the second user via email.
